(19) United States
(12) Patent Application Publication
(10) Pub. No.: US 2013/0119900 A1
(43) Pub. Date: May 16, 2013

(54) MOTOR TORQUE RIPPLE COMPENSATION

(71) Applicants: Joseph Youqing Xiang, Canton, MI (US); Yuan Zhang, Novi, MI (US); Shailesh Shrikant Kozarekar, Novi, MI (US); Michael W. Degner, Novi, MI (US)

(72) Inventors: Joseph Youqing Xiang, Canton, MI (US); Yuan Zhang, Novi, MI (US); Shailesh Shrikant Kozarekar, Novi, MI (US); Michael W. Degner, Novi, MI (US)

(73) Assignee: FORD GLOBAL TECHNOLOGIES, LLC, Dearborn, MI (US)

(21) Appl. No.: 13/293,437

(22) Filed: Nov. 10, 2011

(51) Int. Cl. H02P 21/05; H02P 6/10

(52) U.S. Cl. 318/400.02; 318/400.23

(57) ABSTRACT

A system for controlling a vehicle, the vehicle including an electric machine, includes a controller. The controller is configured to control the electric machine with an electric machine current including a plurality of current harmonic components. At least two of the current harmonic components have different magnitudes. When a torque ripple of the electric machine is an electrical k-th order harmonic, the plurality of current harmonic components may include an electrical k-1 order harmonic component having a first magnitude and an electrical k+1 order harmonic component having a second magnitude different than the first magnitude.

### TECHNICAL FIELD

The invention relates to electric drive torque ripple compensation for hybrid electric vehicles (HEVs), plug-in hybrid electric vehicles (PHEVs), and battery electric vehicles (BEVs).

### BACKGROUND

Hybrid electric vehicles (HEVs) use batteries as an energy storage system. The plug-in hybrid electric vehicle (PHEV) is an extension of existing hybrid electric vehicle (HEV) technology. A PHEV utilizes a larger capacity battery pack than a standard hybrid electric vehicle, and adds the capability to recharge the battery from a standard electrical outlet to decrease fuel consumption and to further improve the fuel economy in an electric driving mode or in a blended driving mode. There are also battery electric vehicle (BEV) applications where an electric machine completely replaces the internal combustion engine.

The HEV, PHEV, and BEV each include an electric motor drive system, which includes a permanent magnet (PM) synchronous motor. A PM synchronous motor includes a rotor having permanent magnets mounted on the rotor periphery or buried inside the rotor. The electric motor drive system generates torque ripple. The motor output torque contains torque ripple caused by the magnetic force variations depending on the rotor position of the motor.

In an existing approach to compensating for torque ripple, a torque harmonics injection method is employed to modify a motor torque command by adding a cancellation ripple torque calculated in terms of the motor rotor position and speed.

Injecting torque harmonics may be difficult, due to difficulties in measuring torque, and due to the fact that the relationship between motor currents, torque, and rotor position is not straightforward.

Background information may be found in U.S. Pat. Nos. 7,768,220, 7,696,709, 7,843,154, 7,538,469, and 6,828,752.

### SUMMARY

In one embodiment of the invention, a system for controlling a vehicle including an electric machine is provided. The system comprising a controller configured to control the electric machine with an electric machine current including a plurality of current harmonic components. At least two of the current harmonic components have different magnitudes.

In one aspect, when a torque ripple of the electric machine is an electrical k-th order harmonic, the plurality of current harmonic components may include an electrical k−1 order harmonic component having a first magnitude and an electrical k+1 order harmonic component having a second magnitude different than the first magnitude.

In another aspect, the controller may be further configured to obtain a plurality of feedback currents from the electric machine; and control the electric machine further based on the feedback currents.

In another embodiment of the invention, a method of controlling a vehicle is provided. The vehicle includes a permanent magnet (PM) synchronous motor. The motor is calibrated such that for each torque command, there are corresponding direct axis (d-axis) and quadrature axis (q-axis) current commands. The method comprises establishing a torque command; determining d-axis and q-axis current commands Id and Iq, respectively, corresponding to the torque command. A plurality of current harmonic components are determined based on rotor position. At least two of the current harmonic components have different magnitudes. The method further comprises controlling the motor based on Id, Iq, and the plurality of current harmonic components.

Embodiments of the invention may include one or more additional features, depending on the application. In one possible feature, when torque ripple of the motor is an electrical k-th order harmonic, the plurality of current harmonic components includes an electrical k−1 order harmonic component having a first magnitude and an electrical k+1 order harmonic component having a second magnitude different than the first magnitude.

In an additional feature, the method further comprises transforming the plurality of harmonic current components into d-axis and q-axis harmonic currents Idh and Iqh, respectively; and controlling the motor based on Id, Idh, Iq, and Iqh.

A plurality of feedback currents may be obtained from the motor. The method may further comprise transforming the plurality of feedback currents into d-axis and q-axis feedback currents Id_fdb and Iq_fdb, respectively; and controlling the motor further based on Id_fdb and Iq_fdb.

In an additional feature, the method further comprises obtaining a plurality of feedback currents from the motor; and determining a plurality of difference currents based on the plurality of harmonic current components and the plurality of feedback currents. The motor is controlled further based on the difference currents.

The plurality of difference currents may be transformed into d-axis and q-axis difference currents Id_fdb and Iq_fdb, respectively, and the motor may be further controlled based on Id_fdb and Iq_fdb.

In another embodiment of the invention, a system for controlling a vehicle is provided. The vehicle includes a permanent magnet (PM) synchronous motor. The motor is calibrated such that for each torque command, there are corresponding direct axis (d-axis) and quadrature axis (q-axis) current commands. The system comprises a controller configured to determine d-axis and q-axis current commands Id and Iq, respectively, corresponding to a torque command; determine a plurality of current harmonic components based on rotor position, at least two of the current harmonic components having different magnitudes; and control the motor based on Id, Iq, and the plurality of current harmonic components.

The system may include any one or more of the various additional features of the invention, depending on the application.

### BRIEF DESCRIPTION OF THE DRAWINGS

FIG. 1 is a schematic representation of a powersplit powertrain system configuration;

FIG. 2 is a schematic representation, in block diagram form, of a powertrain system power flow diagram;

FIG. 3 illustrates an electric motor device, including a motor controller and a permanent magnet (PM) synchronous motor;

FIG. 4 illustrates controlling a vehicle including a permanent magnet (PM) synchronous motor in a first embodiment of the invention;

FIG. 5 illustrates controlling a vehicle including a permanent magnet (PM) synchronous motor in a second embodiment of the invention; and

FIG. 6 illustrates the trajectory of the current in the Id-Iq plane in an embodiment of the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The invention includes various aspects of motor torque ripple compensation. Torque ripple is produced from the interaction of air-gap flux harmonics and stator winding currents. For a given motor design, torque ripple may be minimized by optimizing stator winding currents. In one embodiment of the invention, the dominating torque ripple of an interior permanent magnet motor is the electrical sixth order component which can be canceled out by injecting fifth and seventh order current harmonics into the stator winding.

Embodiments of the invention may be implemented in a variety of applications. One example is a hybrid electric vehicle powertrain.

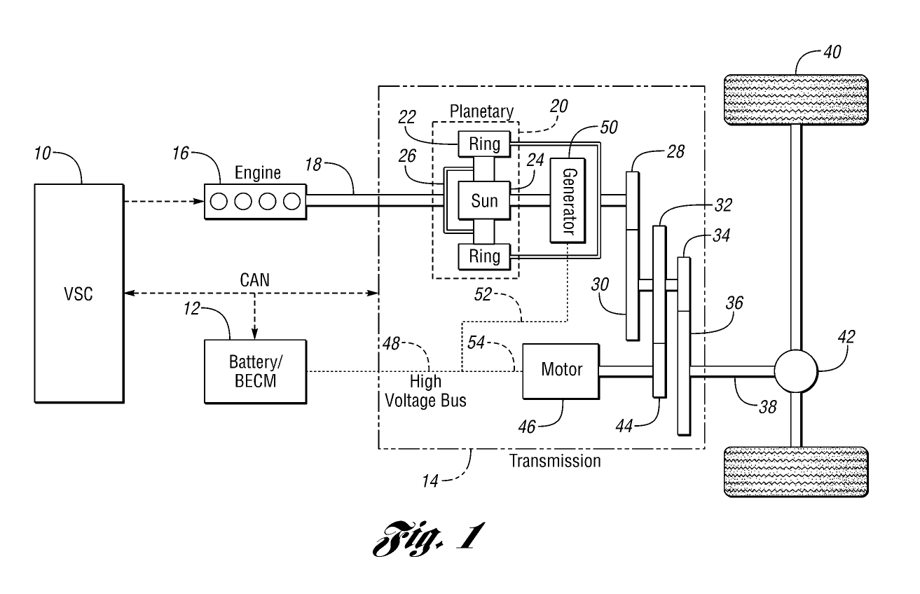

A hybrid electric vehicle powertrain is shown in FIG. 1. A vehicle system controller (VSC) 10, a battery and battery energy control module (BECM) 12, and a transmission 14, together with a motor-generator subsystem, comprise a control area network (CAN). An internal combustion engine 16, controlled by VSC 10, distributes torque through torque input shaft 18 to transmission 14.

The transmission 14 includes a planetary gear unit 20, which comprises a ring gear 22, a sun gear 24, and a planetary carrier assembly 26. The ring gear 22 distributes torque to step ratio gears comprising meshing gear elements 28, 30, 32, 34, and 36. A torque output shaft 38 for the transmission 14 is drivably connected to vehicle traction wheels 40 through a differential and axle mechanism 42.

Gears 30, 32, and 34 are mounted on a countershaft, with gear 32 engaging a motor-driven gear 44. Electric motor 46 drives gear 44, which acts as a torque input for the countershaft gearing.

The battery delivers electric power to the motor through power flow path 48, 54. Generator 50 is connected electrically to the battery and to the motor 46 in a known fashion as shown at 52.

The powersplit powertrain system of FIG. 1 may be operated in a variety of different modes as is appreciated by those skilled in the art. As shown, there are two power sources for the driveline. The first power source is a combination of the engine and generator subsystems, which are connected together using the planetary gear unit 20. The other power source involves the electric drive system including the motor 46, the generator 50, and the battery, where the battery acts as an energy storage medium for the generator 50 and the motor 46.

In general, VSC 10 calculates the total engine power needed to meet the drive wheel power demand plus all accessory loads, and independently schedules the engine speed and load operating point, with or without feedback of actual engine performance, to meet the total power demand. This type of approach is typically used to maximize fuel economy and may be used in other types of powertrain systems that have such VSCs.

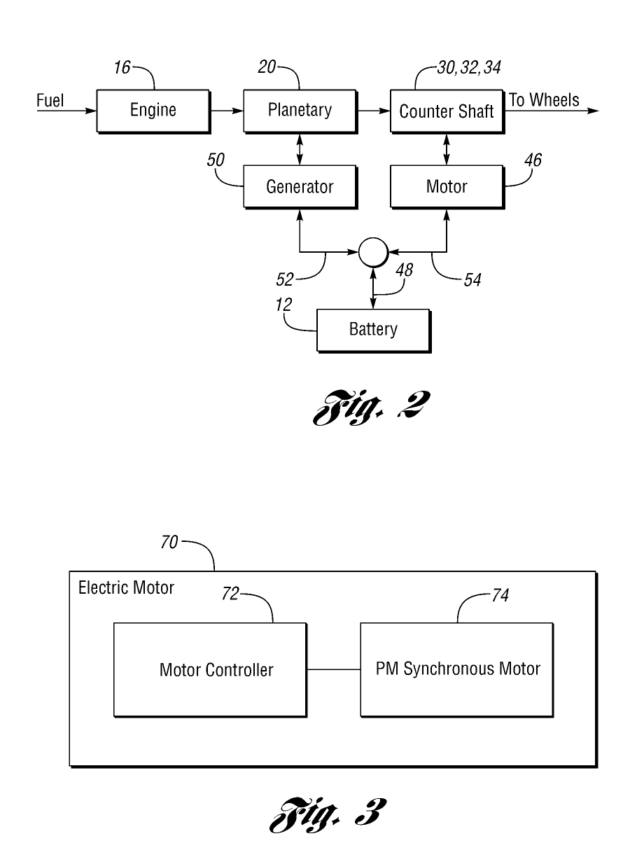

The power flow paths between the various elements of the powersplit powertrain diagram shown in FIG. 1 are illustrated in FIG. 2. Fueling is scheduled based on driver and other inputs. Engine 16 delivers power to the planetary gear unit 20. The available engine brake power is reduced by accessory loads. Power is delivered by the planetary ring gear to the countershaft gears 30, 32, 34. Power output from the transmission drives the wheels.

Generator 50, when acting as a motor, can deliver power to the planetary gearing. When acting as a generator, generator 50 is driven by the planetary gearing. Similarly, power distribution between the motor 46 and the countershaft gears 30, 32, 34 can be distributed in either direction.

As shown in FIGS. 1 and 2, engine power output can be split into two paths by controlling generator 50. In operation, the system determines the driver's demand for torque and achieves the optimum split of power between the two power sources.

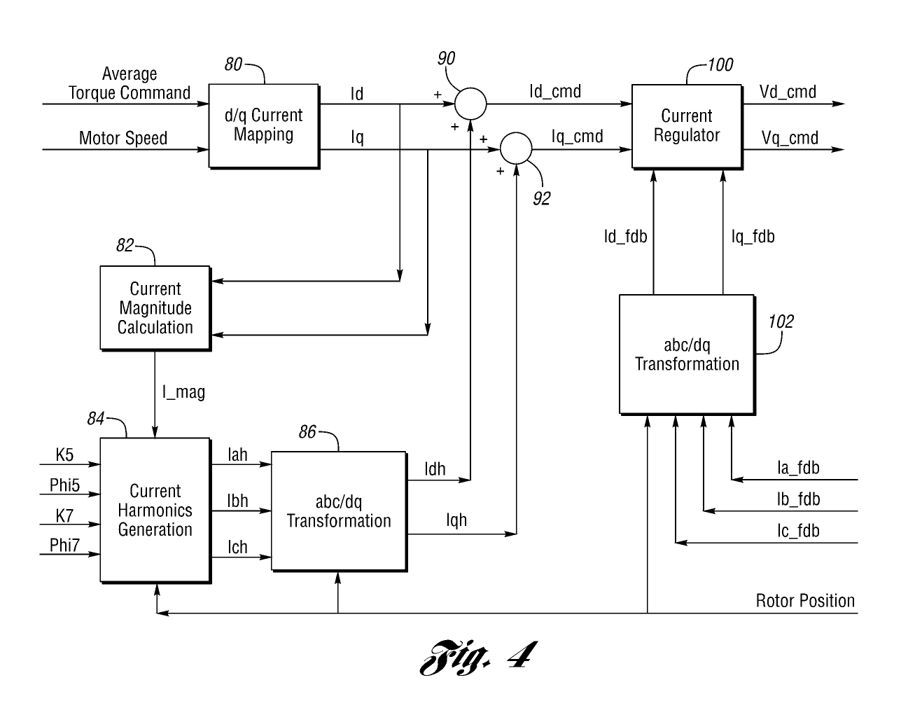

FIG. 3 illustrates an electric motor 70. Electric motor 70 includes motor controller 72 and permanent magnet (PM) synchronous motor 74. Electric motor 70 may be controlled in accordance with an embodiment of the invention. Embodiments of the invention are useful in hybrid and electric vehicles that use PM synchronous motors. For example, motor 46 or generator 50 (FIGS. 1 and 2) may be implemented as a PM synchronous motor, and electric motor 70 may represent motor 46 or generator 50. Embodiments of the invention are also useful in other applications, and electric motor 70 may represent some other electric motor.

In general, electric motor 70, in this example, operates by providing a torque command to the motor controller 72 which controls PM synchronous motor 74 and attempts to provide the commanded torque output. Motor controller 72 may receive other inputs such as, for example, available voltage and current motor speed, as appreciated by those skilled in the art.

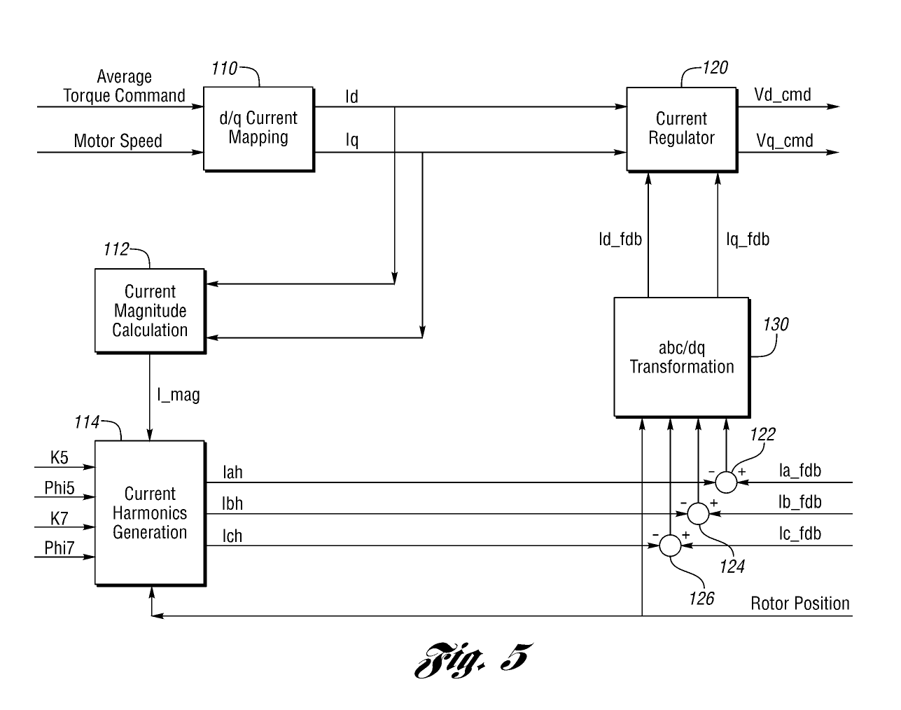

In more detail, FIG. 4 illustrates an example method of controlling PM synchronous motor 74. The electric motor is calibrated such that for each torque command, there are corresponding direct-axis (d-axis) and quadrature axis (q-axis) currents, as depicted at d/q current mapping look-up table 80. In this example, the look-up table 80 is used to determine d-axis current Id and q-axis current Iq based on average torque command provided to the motor controller, and on motor speed. Current magnitude calculation block 82 calculates current magnitude as:

I_mag=sqrt(Id*Id+Iq*Iq)

Current harmonics generation block 84 receives rotor position and generates three-phase harmonic currents, calculated as:

Iah=I_mag*(K5cos(5*Theta+Phi5)+K7cos(7*Theta+Phi7))

Ibh=I_mag*(K5cos(5*(Theta−120)+Phi5)+K7cos(7*(Theta−120)+Phi7))

Ich=I_mag*(K5cos(5*(Theta−240)+Phi5)+K7cos(7*(Theta−240)+Phi7))

K5 and K7 are the magnitudes of the fifth and seventh order harmonic components, respectively. Phi5 and Phi7 are the phase angles for the fifth and seventh order harmonic components, respectively. Theta is the rotor position.

Abc/dq transformation block 86 receives the rotor position and transforms the three-phase harmonic currents Iah, Ibh, Ich into d/q currents Idh and Iqh in a known manner. Harmonic current Idh is summed with d-axis current Id at summer 90 to produce d-axis current command Id_cmd. Harmonic current Iqh is summed with q-axis current Iq at summer 92 to produce q-axis current command Iq_cmd.

PM synchronous motor 74 is controlled based on Id_cmd and Iq_cmd by current regulator 100. In more detail, current regulator 100 produces d-axis voltage command Vd_cmd and q-axis voltage command Vq_cmd. In turn, actual three-phase feedback currents Ia_fdb, Ib_fdb, Ic_fdb are measured. Abc/dq transformation block 102 receives the rotor position and transforms the three-phase feedback currents Ia_fbd, Ib_fbd, Ic_fbd into d/q currents Id_fdb and Iq_fdb in a known manner. Current regulator 100 receives Id_fdb and Iq_fdb.

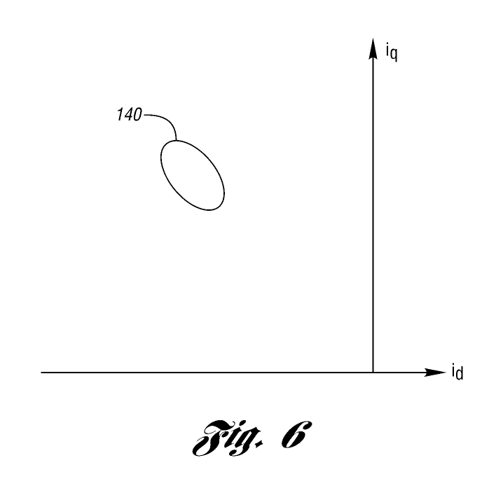

FIG. 5 illustrates a second example of controlling PM synchronous motor 74. For each torque command, there are corresponding direct-axis (d-axis) and quadrature axis (q-axis) currents, as depicted at d/q current mapping look-up table 110. In this example, the look-up table 110 is used to determine d-axis current Id and q-axis current Iq based on average torque command provided to the motor controller, and on motor speed. Current magnitude calculation block 112 calculates current magnitude I_mag as described previously.

Current harmonics generation block 114 receives: K5 and K7 which are the magnitudes of the fifth and seventh order harmonic components, Phi5 and Phi7 which are the phase angles for the fifth and seventh order harmonic components, and rotor position. Current harmonics generation block 114 generates three-phase harmonic currents Iah, Ibh, Ich, calculated as described previously.

In FIG. 5, the three-phase harmonic currents Iah, Ibh, Ich are subtracted from the actual three-phase feedback currents Ia_fdb, Ib_fdb, Ic_fdb at summers 122, 124, 126, respectively. Abc/dq transformation block 130 receives the rotor position and transforms the three-phase difference currents from the outputs of summers 122, 124, 126 into d/q currents Id_fdb and Iq_fdb in a known manner.

PM synchronous motor 74 is controlled based on Id and Iq, and on Id_fdb and Iq_fdb, by current regulator 120. In more detail, current regulator 120 produces d-axis voltage command Vd_cmd and q-axis voltage command Vq_cmd.

FIGS. 4 and 5 are examples of controlling PM synchronous motor 74; other control techniques are possible. Embodiments of the invention allow current harmonic components to have different magnitudes (for example, K5 and K7 are not the same value).

In one aspect of the invention, based on finite element analysis calculation for a particular PM synchronous motor, an optimal current waveform can be obtained to reduce electromagnetic torque ripple. The optimal current waveform is not sinusoidal and its major harmonics are 5^{th}, 7^{th}, 11^{th}, 13^{th}, 17^{th}, 19^{th}, 23^{rd}, and 25^{th}. When optimal currents are applied, the torque ripples are reduced significantly for both skewed and un-skewed rotors.

Embodiments of the invention have many advantages. For example, current harmonic injection methods are based on the physics of torque ripple production of interior permanent magnet motors. The current harmonic injection method is effective for torque ripple cancellation. In one aspect, the invention performs torque ripple cancellation based on current harmonics as opposed to torque harmonics. The invention comprises various approaches for generating current harmonics, and the above examples for 5^{th} and 7^{th} harmonics are suitable for a particular application; other applications may involve other current harmonic components, wherein the current harmonic components may have different magnitudes.

FIG. 6 illustrates the trajectory of the current in the Id-Iq plane in an embodiment of the invention. As shown, embodiments of the invention allow different magnitudes for the harmonics (for example, 5^{th} and 7^{th} harmonics). The current trajectory, shown at 140, may be an ellipse of any shape, a circle, or a line, which helps to reduce copper loss potentially for the torque ripple compensation. Put another way, the phase shift between Id and Iq can be any value.

It is appreciated that embodiments of the invention are not limited to PM machines, and other applications include induction machines, synchronous machines, and others. Put another way, embodiments of the invention are suitable for various electric machines.

Further, it is appreciated that embodiments of the invention are not limited to current control based on Id and Iq. This is one form of control and others are possible, for example; three-phase current feedback control, alpha-beta current feedback control, control based on any two unparalleled axes of current vectors.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for controlling a vehicle including an electric machine, the system comprising a controller configured to:
control the electric machine with an electric machine current including a plurality of current harmonic components, at least two of the current harmonic components having different magnitudes.

2. The system of claim 1 wherein a torque ripple of the electric machine is an electrical k-th order harmonic, wherein the plurality of current harmonic components includes an electrical k−1 order harmonic component having a first magnitude and an electrical k+1 order harmonic component having a second magnitude different than the first magnitude.

3. The system of claim 2 wherein the controller is further configured to:
obtain a plurality of feedback currents from the electric machine; and
control the electric machine further based on the feedback currents.

4. The system of claim 1 wherein the controller is further configured to:
obtain a plurality of feedback currents from the electric machine; and
control the electric machine further based on the feedback currents.

5. A method of controlling a vehicle including a permanent magnet (PM) synchronous motor, the motor being calibrated such that for each torque command, there are corresponding direct axis (d-axis) and quadrature axis (q-axis) current commands, the method comprising:
establishing a torque command;
determining d-axis and q-axis current commands Id and Iq, respectively, corresponding to the torque command;
determining a plurality of current harmonic components based on rotor position, at least two of the current harmonic components having different magnitudes; and
controlling the motor based on Id, Iq, and the plurality of current harmonic components.

6. The method of claim 5 wherein a torque ripple of the motor is an electrical k-th order harmonic, wherein the plurality of current harmonic components includes an electrical k−1 order harmonic component having a first magnitude and an electrical k+1 order harmonic component having a second magnitude different than the first magnitude.

7. The method of claim 6 further comprising:
transforming the plurality of harmonic current components into d-axis and q-axis harmonic currents Idh and Iqh, respectively; and
controlling the motor based on Id, Idh, Iq, and Iqh.

8. The method of claim 7 further comprising:
obtaining a plurality of feedback currents from the motor;
transforming the plurality of feedback currents into d-axis and q-axis feedback currents Id_fdb and Iq_fdb, respectively; and
controlling the motor further based on Id_fdb and Iq_fdb.

9. The method of claim 6 further comprising:
obtaining a plurality of feedback currents from the motor;
determining a plurality of difference currents based on the plurality of harmonic current components and the plurality of feedback currents; and
controlling the motor further based on the difference currents.

10. The method of claim 9 further comprising:
transforming the plurality of difference currents into d-axis and q-axis difference currents Id_fdb and Iq_fdb, respectively; and
controlling the motor further based on Id_fdb and Iq_fdb.

11. The method of claim 5 further comprising:
transforming the plurality of harmonic current components into d-axis and q-axis harmonic currents Idh and Iqh, respectively; and
controlling the motor based on Id, Idh, Iq, and Iqh.

12. The method of claim 5 further comprising:
obtaining a plurality of feedback currents from the motor;
determining a plurality of difference currents based on the plurality of harmonic current components and the plurality of feedback currents; and
controlling the motor further based on the difference currents.

13. A system for controlling a vehicle including a permanent magnet (PM) synchronous motor, the motor being calibrated such that for each torque command, there are corresponding direct axis (d-axis) and quadrature axis (q-axis) current commands, the system comprising a controller configured to:
determine d-axis and q-axis current commands Id and Iq, respectively, corresponding to a torque command;
determine a plurality of current harmonic components based on rotor position, at least two of the current harmonic components having different magnitudes; and
control the motor based on Id, Iq, and the plurality of current harmonic components.

14. The system of claim 13 wherein a torque ripple of the motor is an electrical k-th order harmonic, wherein the plurality of current harmonic components includes an electrical k-1 order harmonic component having a first magnitude and an electrical k+1 order harmonic component having a second magnitude different than the first magnitude.

15. The system of claim 14 wherein the controller is further configured to:
transform the plurality of harmonic current components into d-axis and q-axis harmonic currents Idh and Iqh, respectively; and
control the motor based on Id, Idh, Iq, and Iqh.

16. The system of claim 15 wherein the controller is further configured to:
obtain a plurality of feedback currents from the motor;
transform the plurality of feedback currents into d-axis and q-axis feedback currents Id_fdb and Iq_fdb, respectively; and
control the motor further based on Id_fdb and Iq_fdb.

17. The system of claim 14 wherein the controller is further configured to:
obtain a plurality of feedback currents from the motor;
determine a plurality of difference currents based on the plurality of harmonic current components and the plurality of feedback currents; and
control the motor further based on the difference currents.

18. The system of claim 17 wherein the controller is further configured to:
transform the plurality of difference currents into d-axis and q-axis difference currents Id_fdb and Iq_fdb, respectively; and
control the motor further based on Id_fdb and Iq_fdb.

19. The system of claim 13 wherein the controller is further configured to:
transform the plurality of harmonic current components into d-axis and q-axis harmonic currents Idh and Iqh, respectively; and
control the motor based on Id, Idh, Iq, and Iqh.

20. The system of claim 13 wherein the controller is further configured to:
obtain a plurality of feedback currents from the motor;
determine a plurality of difference currents based on the plurality of harmonic current components and the plurality of feedback currents; and
control the motor further based on the difference currents.
